(19) United States
(12) Patent Application Publication
(10) Pub. No.: US 2023/0320405 A1
(43) Pub. Date: Oct. 12, 2023

(54) PROFOOD ITEM AND PUFFED FOOD PRODUCT PREPARATIONS

(71) Applicant: TUTTIPUFFS LTD., Sde-Nechemia (IL)

(72) Inventors: Zemer SAT, Kibbutz Hulata (IL); Gilad AHARONSON, Kibbutz Sde-Nechemia (IL)

(73) Assignee: TUTTIPUFFS LTD., Sde-Nechemia (IL)

(21) Appl. No.: 18/041,942

(22) PCT Filed: Aug. 19, 2021
(86) PCT No.: PCT/IL2021/051015

§ 371 Date: Feb. 16, 2023

(30) Foreign Application Priority Data
Aug. 19, 2020 (IL) 276820

(51) Int. Cl. A23P 30/36; A23L 29/212; A23P 20/10; A23L 19/00; A23P 30/20

(52) U.S. Cl. CPC A23P 30/36; A23L 29/212; A23P 30/20; A23L 19/01; A23P 20/10

(57) ABSTRACT

A profood item for preparing a puffed food product and method for producing the profood item. Profood item shell comprises a first foodstuff, the shell characterized by a hardness and rigidity able to withstand breakage when subject to temperature/pressure below breakage threshold conditions. Profood item interior contained within shell comprises a second foodstuff comprising at least one starch and a liquid adapted to form a vapor when subjected to heating, where an increased pressure of the vapor when heated causes a rupturing of the shell when breakage threshold conditions reached, inducing a sudden release of vapor at high pressure resulting in puffing of starch to produce puffed food product. The profood item micropellet may be prepared using an extrusion process and coated with a coating process to form a shell.

### FIELD OF THE INVENTION

The present invention generally relates to food products, and particularly to puffed food products and methods for their preparation.

### BACKGROUND OF THE INVENTION

Puffed foods can be found in a variety of commercial food products accessible in supermarkets and grocery stores, including different types of snacks, chips, and breakfast cereals. These puffed foods come in various shapes, sizes and textures, and are made from a basic foodstuff item which expands in volume and puffs up when heated. More specifically, puffed food preparation entails subjecting a foodstuff, such as a natural grain (e.g., wheat, rice, corn) or previously prepared micropellets (typically containing various food flours), to heating, usually concurrent with a pressure escalation, for a relatively brief duration (e.g., several seconds or minutes). As internal pressure in the heated foodstuff is intensified, naturally contained water or moisture is converted into vapor. The heating also causes naturally contained biopolymer compounds characterized by thermoplastic properties, such as starch, to become soft and pliable. Eventually the internal pressure reaches a critical point (Pc) resulting in a forceful explosion and sudden expansion of the contained biopolymer material (e.g., starch). The dynamics of this explosion at the critical point is dependent on various factors, including the internal pressure of the basic foodstuff item, the pressure differential (AP) between the external and internal pressures, the process temperature, the time exposure to heat, and other variables. Following the explosion and the rapid release of pressure, the foodstuff matrix rapidly cools, lowering the temperature such that the biopolymer or starch is solidified, leaving it in a puffy, porous, expanded and loose arrangement.

For example, one of the most common and well-known puffed foods is popcorn. A popcorn kernel contains a starchy endosperm contained within a shell or hull. Upon heating of the kernel, the endosperm moisture transforms into steam and the steam pressure gradually intensifies until the shell ruptures, and the starch and proteins of the endosperm expand into a foamy material, which then rapidly cools and takes on a puffed form. Puffed foods may be prepared from a single foodstuff, but may include additional ingredients and additives to enhance flavor and entice the consumer. Some puffed food products may form a shell or crust due to the heating, such as with bread.

The raw ingredients may be formed into desired shapes prior to heating, such as via an extrusion or pressing process. The heating of the puffing foodstuff may be performed by baking or frying, using conventional heating utensils and appliances, such as an oven, a pan or a lidded pot, or specially designated devices, such as a puffing machine with pressing molds. In a conventional baking process, expansion of the ingredients usually results from an external leavening agent, such as yeast in bread dough, which instigates the emission of gas bubbles within the dough. Accordingly, the expansion generally takes place prior to the actual baking stage (i.e., before the dough is placed in the oven) and at the very beginning of baking. In contrast, expansion of a puffing foodstuff results from internal elements, specifically water or moisture naturally contained within the basic foodstuff item. This moisture reaches a vapor state upon heating and subsequently generates sufficient pressure required to initiate expansion of the contained starches. Therefore, the preparation of puffed foods does not require a lengthy waiting period for foodstuff expansion prior to the heating and pressing stages.

Certain basic foodstuffs can be used to prepare puffed foods in a straightforward process and without requiring specially designated machines or devices. For example, popcorn can be prepared relatively quickly and conveniently at the comfort of one's home from readily available popcorn kernels that can be heated in a pot or a bag. Yet other types of puffed foods, such as certain snacks and cereals that tend to be popular with young children, need to be produced by commercial manufacturers in designated facilities. While there are many existing foodstuff items, techniques, and devices for preparation of puffed food items, the types and varieties of puffed foods can be greatly expanded beyond those currently available.

Various puffed food products and related production techniques are known in the art. Some examples are disclosed in: U.S. Pat. No. 6,511,691 to Willoughby et al, entitled: “Food products and co-injection processes for preparing same”; U.S. Patent Application No. 2013/0251877 to Levin et al, entitled: “Snack products and method for producing same”; U.S. Patent Application No. 2006/0013925 to Bauman et al, entitled: “Vacuum puffed and expanded fruit”; U.S. Pat. No. 4,948,609 to Nafisi-Movaghar, entitled: “Fruit and vegetable dried food product”; and Korean Patent No. 101908530 to Korea Food Res Inst, entitled: “Manufacturing method of puffed nuts granule snack and puffed nuts granule snack prepared therefrom”.

### SUMMARY OF THE INVENTION

In accordance with one aspect of the present invention, there is thus provided a profood item for preparing a puffed food product. The profood item includes a shell comprising a first foodstuff, the shell characterized by a hardness and rigidity able to withstand breakage when subject to a temperature and pressure below breakage threshold conditions. The profood item further includes an interior, contained within the shell, the interior comprising a second foodstuff comprising: at least one starch; and a liquid adapted to form a vapor when subjected to heating. An increased pressure of the vapor when the profood item is subjected to heating causes a rupturing of the shell when the breakage threshold conditions is reached, inducing a sudden release of the vapor at a high pressure, resulting in puffing of the starch to produce the puffed food product. The second foodstuff may include at least 10% (w/w interior), or at least 15% (w/w interior) of at least one of: edible root plants; edible bulbs; potato; sweet potato; radish; cassava; tapioca beet; lentil; chickpea; sweet pea; edible mushroom; bell pepper; hot pepper; chilli pepper; tomato; zucchini; pumpkin; onion; garlic; celery; spinach; apple; citrus fruit; blueberry; blackberry; raspberry; egg; cheese; milk or derivatives thereof; meat and meat substitutes; fish and fish substitutes; algae and/or seaweed; soy; bean; legume; avocado; avocado pit; teff; barley; moringa; quinoa; amaranth; pectin; alginic acid; alginate; beta-glucans; chitosan; cellulose nanocrystal (CNC); whey; prolamin; avenin; gliadin; hordein; secalin; kafirin; soy; soy derived proteins; preparations thereof; and mixtures thereof. The first foodstuff may include at least 10% (w/w interior) of at least one of: zein; edible cellulose; edible fatty acids; lipids; furfuryl alcohol; polysaccharide; bran; natural edible fibre; plant derived edible thermoplasts; edible biopolymers; lignin; lignin-polysaccharide combinations; starch; lignin-starch combinations; amylose; amylopectin; amylose-amylopectin combinations; amaranth; pectin; alginic acid; alginate; beta-glucans; chitosan; cellulose nanocrystal (CNC); whey; prolamin; avenin; gliadin; hordein; secalin; kafirin; bean; pea; chickpea; lentil; preparations thereof; and mixtures thereof. The second foodstuff may include less than 10% (w/w interior) of at least one of: dried sorghum, rice, corn, wheat, potato, cereals and mixtures thereof. The profood item may not include at least one of: drageés, chocolate covered nuts and fruit, frozen foods, processed cheese, nuggets, and crunchy nuts. The second foodstuff may include 10-35% w/w of a natural plant derived starch. The configuration of the profood item may include at least one of: a coated pellet; a coated pellet comprising an interior comprising natural grains; a coated pellet comprising an interior comprising foodstuffs of at least one of: dried vegetables; and diced fruits; a coated pellet comprising an interior comprising: a first portion including a first set of foodstuffs; and a second portion including a second set of foodstuffs; a coated pellet comprising an interior divided in a hemispherical configuration; a coated pellet comprising an interior divided in a core and shroud configuration; a coated pellet comprising an interior comprising a first set of foodstuffs and a second set of foodstuffs; and an agglomerate of conjoined pellets, each of the conjoined pellets comprising a respective pellet configuration.

In accordance with another aspect of the present invention, there is thus provided a method for producing a profood item used for preparing a puffed food product. The method includes the procedure of preparing a micropellet, the micropellet comprising a second foodstuff comprising: at least one starch; and a liquid adapted to form a vapor when subjected to heating. The method further includes the procedure of coating the micropellet to form a shell comprising a first foodstuff, the shell characterized by a hardness and rigidity able to withstand breakage when subject to a temperature and pressure below breakage threshold conditions, where an increased pressure of the vapor when subjected to heating causes a rupturing of the shell when breakage threshold conditions of the shell is reached, inducing a sudden release of the vapor at a high pressure, resulting in puffing of the starch to produce the puffed food product. Preparing the micropellet may include at least one sub-procedure of: preparing a dry foodstuff according to a predefined recipe; mixing the prepared dry foodstuff material; adding water to the mixed material and further mixing; feeding resultant mass through an extruder; cutting up extruded mass to form at least one micropellet of a selected size and shape; and drying the formed micropellet. Coating the micropellet to form a shell may include at least one sub-procedure of: placing at least one prepared micropellet in a designated device for coating; adding a coating material mixture to the micropellet; heating and tumbling the micropellet to create an outer shell; cooling and/or drying the coated micropellet; and packaging the coated micropellet.

In accordance with yet another aspect of the present invention, there is thus provided a puffed food product prepared from a profood item that includes a shell comprising a first foodstuff, the shell characterized by a hardness and rigidity able to withstand breakage when subject to a temperature and pressure below breakage threshold conditions, the profood item further including an interior, contained within the shell, the interior comprising a second foodstuff comprising: at least one starch; and a liquid adapted to form a vapor when subjected to heating, where an increased pressure of the vapor when the profood item is subjected to heating causes a rupturing of the shell when the breakage threshold conditions is reached, inducing a sudden release of the vapor at a high pressure, resulting in puffing of the starch to produce the puffed food product.

In accordance with yet a further aspect of the present invention, there is thus provided a method for preparing a puffed food product. The method includes the procedure of providing a profood item that includes a shell comprising a first foodstuff, the shell characterized by a hardness and rigidity able to withstand breakage when subject to a temperature and pressure below breakage threshold conditions, the profood item further including an interior, contained within the shell, the interior comprising a second foodstuff comprising: at least one starch; and a liquid adapted to form a vapor when subjected to heating. The method further includes the procedures of heating the profood item to induce the liquid contained within the second foodstuff to form a vapor, and heating the profood item to induce an increased pressure of the vapor within the interior, until a rupturing of the shell at the breakage threshold conditions induces a sudden release of a high pressure of the vapor resulting in puffing of the starch to produce the puffed food product.

### BRIEF DESCRIPTION OF THE DRAWINGS

The present invention will be understood and appreciated more fully from the following detailed description taken in conjunction with the drawings in which:

FIG. 1 is a flow diagram of a method for preparing a puffed food product, operative in accordance with an embodiment of the present invention;

FIG. 2A is a cross-sectional schematic illustration of a natural grain seed that may undergo a puffing process;

FIG. 2B is a cross-sectional schematic illustration of a commercially available micropellet that may undergo a puffing process;

FIG. 2C is a cross-sectional schematic illustration of a coated pellet profood item prepared in accordance with an embodiment of the present invention;

FIG. 2D is a cross-sectional schematic illustration of a pellet profood item with enclosed natural grains, prepared in accordance with an embodiment of the present invention;

FIG. 2E is a cross-sectional schematic illustration of a pellet profood item with enclosed foodstuffs, prepared in accordance with an embodiment of the present invention;

FIG. 2F is a cross-sectional schematic illustration of a pellet profood item with a hemispherical multi-component configuration, prepared in accordance with an embodiment of the present invention;

FIG. 2G is a cross-sectional schematic illustration of a pellet profood item with a core and shroud multi-component configuration, prepared in accordance with an embodiment of the present invention;

FIG. 2H is a cross-sectional schematic illustration of a pellet profood item with a multi-component and multi-ingredient configuration, prepared in accordance with an embodiment of the present invention;

FIG. 2I is a cross-sectional schematic illustration of a conglomerate profood item of conjoined pellets with different ingredients and configurations, prepared in accordance with an embodiment of the present invention;

FIG. 3A is an illustration of an apparatus for preparation of a puffed food product, in a first stage of operation, constructed and operative in accordance with an embodiment of the present invention;

FIG. 3B is an illustration of the apparatus of FIG. 3A for preparation of a puffed food product, in a second stage of operation, constructed and operative in accordance with an embodiment of the present invention;

FIG. 3C is an illustration of the apparatus of FIG. 3A for preparation of a puffed food product, in a third stage of operation, constructed and operative in accordance with an embodiment of the present invention;

FIG. 4 is a flow diagram of a method for preparing a profood item, operative in accordance with an embodiment of the present invention;

FIG. 5A is an illustration of initial stages of a production process for preparation of a profood item, operative in accordance with an embodiment of the present invention;

FIG. 5B is an illustration of intermediate stages of the production process for preparation of a profood item, operative in accordance with an embodiment of the present invention;

FIG. 5C is an illustration of final stages of the production process for preparation of a profood item, operative in accordance with an embodiment of the present invention; and

FIG. 6 is a schematic illustration comparing the nutritional degradation profile of a commercial puffing process and puffed food product (left) with the nutritional degradation profile of the disclosed puffing process and puffed food product in accordance with embodiments of the present invention (right).

### DETAILED DESCRIPTION OF THE EMBODIMENTS

The present invention overcomes the disadvantages of the prior art by providing novel puffed food products and methods for their preparation, as well as novel profood items for producing such puffed food products, and methods for their preparation. It is believed that the disclosed aspects and embodiments include food items that are not commercially available or known as profood items or puffed food products. The disclosed products and methods are considered to significantly broaden the scope of foods, foodstuffs and food sources that can be prepared into an edible puffed form.

The term “profood item” is used herein to refer to any processed or unprocessed food substance, which may be prepared from one or more raw materials (“foodstuffs”), which is not limited to known food items, and which may be used to prepare a “puffed food product” directly, i.e., such that no supplemental ingredients may need to be added to the profood item in order to prepare the puffed food therefrom.

The term “foodstuff” is used herein to refer to any processed or unprocessed food substance which may be used to prepare a “profood item”.

The terms “puffed food” and “puffed food product” are used herein to refer to any food product prepared from a “profood item” in a puffing preparation process (e.g., involving heating and/or internal pressure escalation) and which is characterized by a puffed formation, such as a foamy, fluffy, expanded, “sponge-like” configuration, of one or more food substances.

The terms “pellet” and “micropellet” are used interchangeably herein to refer to a small pellet, tablet or capsule, which may form at least part of a “profood item”.

The term “compartment” as used herein refers to a distinct section of a structure or container, or a mold or mold cavity, in which selected items can be kept separate from other items within the container, such as a section including one or more mold cavities.

The term “treatment”, and grammatical variations thereof, as used herein in the context of profood item preparation, such as in preparing the profood shell, refers to the employment of force or energy, such as heat (e.g., via cooking), and/or mechanical force (e.g. by means of a mixer or a fluid bed), and/or one or more chemical processes which may or may not alter the chemical composition of an outer layer of a foodstuff, and may alter at least one property of the foodstuff, such as applying a coating to a micropellet, and/or otherwise causing one or more outer layers to have increased hardness and rigidity relative to one or more inner layers of the foodstuff.

The term “user” is used herein to refer to any individual person or group of persons operating a device or apparatus or system or performing a method or process of the disclosed embodiments, such as a puffed food preparation method.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the “inclusive or” rather than the “exclusive or”, and indicates at least one of, or any combination of items it conjoins.

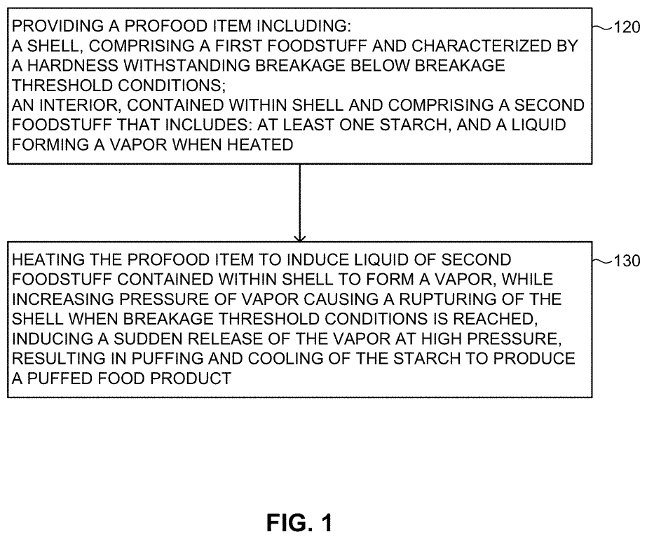

Reference is now made to FIG. 1, which is a flow diagram of a method for preparing a puffed food product, operative in accordance with an embodiment of the present invention. In procedure 120, a profood item is provided. The profood item includes a shell and an interior. The shell includes a first foodstuff and is characterized by a hardness able to withstand breakage below certain temperature and pressure threshold conditions. The interior is contained within the shell and includes a second foodstuff. The second foodstuff includes at least one starch and a liquid, such as water, adapted to form a vapor when heated. The starch may be in a refined form, or as naturally included within the natural ingredients.

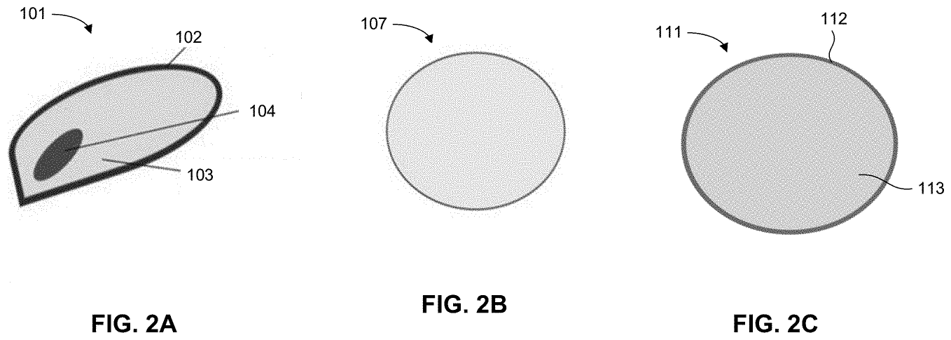

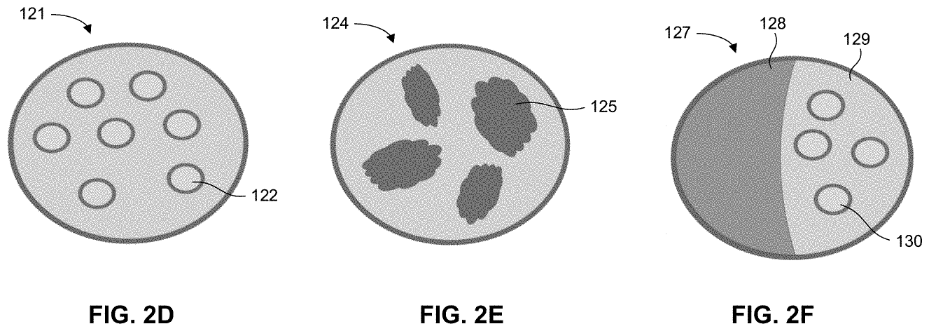

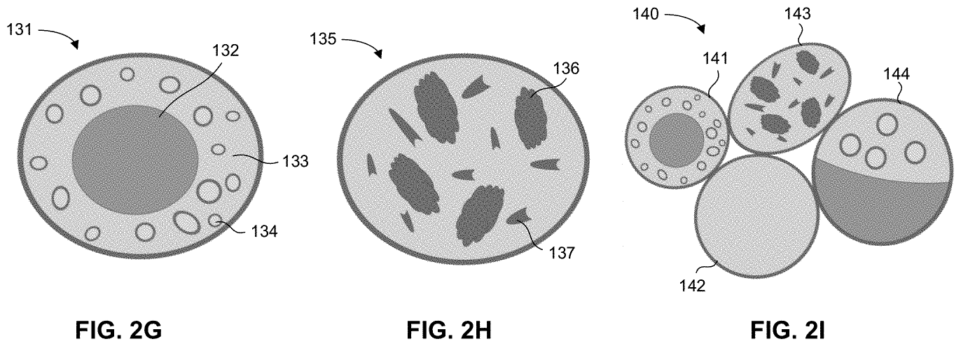

Reference is made to FIGS. 2A through 2C. FIG. 2A is a cross-sectional schematic illustration of a natural grain seed (left), referenced 101, that may undergo a puffing process. Natural grain seed 101 is a seed or kernel 101 of a natural grain such as wheat, rice, corn or quinoa, that may undergo a puffing preparation process. Natural grain seed 101 includes an outer shell 102 containing an endosperm 103 and a germ 104. The outer shell 102 is rich in fiber and protects the germ 104 which is the seed embryo that germinates to initiate plant growth. The endosperm 103 surrounds the germ 104 and provides nutrition primarily in the form of starch but may also include oils and proteins. The germ 104 may be separated from the endosperm 103 in a milling process. FIG. 2B is a cross-sectional schematic illustration of a commercially available micropellet, referenced 107, that may undergo a puffing process. In contrast to natural grain seed 101, commercially available micropellet 107 does not include any shell and is simply a spherical or cylindrical synthetic grain containing a mix of foodstuffs, such as different starchy flours, which are extruded and cut, similar to the production of short pasta products.

FIG. 2C is a cross-sectional schematic illustration of a coated pellet profood item, referenced 111, prepared in accordance with an embodiment of the present invention. Profood item 111 includes an outer shell 112 encasing an interior 113. Profood item 111 may be in the form of a coated micropellet, produced using a profood production method (which will be elaborated upon further hereinbelow). While profood item 111 is generally depicted and described herein as a micropellet for exemplary purposes, a profood item may include alternative or additional forms in accordance with embodiments of the present invention.

Profood shell 112 includes a first foodstuff which may be natural or synthetic. The first foodstuff of profood shell 112 may include at least 10% weight by weight (w/w) or weight percentage of the shell of one or more of the following substances or compounds: zein; edible cellulose; edible fatty acids; lipids; furfuryl alcohol; polysaccharide; bran; natural edible fibre; plant derived edible thermoplasts; edible biopolymers; lignin; lignin-polysaccharide combinations; starch; lignin-starch combinations; amylose; amylopectin; amylose-amylopectin combinations; amaranth; pectin; alginic acid; alginate; beta-glucans; chitosan; cellulose nanocrystal (CNC); whey; prolamin; avenin; gliadin; hordein; secalin; kafirin; bean; pea; chickpea; lentil; and or other materials characterized by similar properties such as the ability to create a coating as described, as well as preparations and mixtures thereof. Profood shell 112 may generally be produced from natural or partially synthesized edible compounds. For example, profood shell 112 may be composed of alternating coatings of edible (tapioca) starch and edible fibers (cellulose).

Profood interior 113 includes a second foodstuff that contains starch and a liquid (e.g., water) forming a vapor when heated. The second foodstuff of profood interior 113 may include at least 10% weight by weight (w/w) or weight percentage, such as at least 15% w/w, of one or more of the following substances or compounds: a variety of vegetables such as: edible root plants; edible bulbs; potato; sweet potato; radish; cassava; tapioca; beet; lentil; chickpea; sweet pea; edible mushroom; bell pepper; hot pepper; chilli pepper; tomato; zucchini; pumpkin; onion; garlic; celery; spinach; a variety of fruits and berries such as: apple; citrus fruit; blueberry; blackberry; raspberry; egg; cheese; milk or derivatives thereof; meat and meat substitutes; fish and fish substitutes; algae and/or seaweed; soy; bean; legume; avocado; avocado pit; teff; barley; moringa; quinoa; amaranth; pectin; alginic acid; alginate; beta-glucans; chitosan; cellulose nanocrystal (CNC); whey; prolamin; avenin; gliadin; hordein; secalin; kafirin; soy; soy derived proteins; and preparations and mixtures thereof. It is appreciated that such concentrations (of at least one of the aforementioned exemplary substances/compounds) are typically beyond the capabilities of commercially available technologies for profood micropellet preparation, which generally provide these second foodstuffs at concentrations that do not exceed approximately 5-10% w/w interior. In particular a second foodstuff concentration) of at least 15% w/w interior is significantly higher than those achievable by conventional commercial technologies. The second foodstuff may include less than 10% weight by weight (w/w) of one or more of the following foodstuffs: sorghum; rice; corn; wheat; potato, cereals, and preparations and mixtures thereof. The second foodstuff may include a certain percentage, such as between 10%-35% weight by weight (w/w), of a natural plant-derived starch.

According to an embodiment of the present invention, the profood does not include one or more of the following foodstuffs: a dragee or confetto (a confectionery with a coated central item such as a nut or fruit); a coated nut or fruit (e.g., chocolate or sugar coated almond); a frozen food; processed cheese; and a candied nut.

A profood pellet configured to undergo puffing in accordance with the claimed invention may include additional forms and configurations, as depicted in FIGS. 2D through 2I. FIG. 2D is a cross-sectional schematic illustration of a profood item pellet 121 with enclosed natural grains 122, prepared in accordance with an embodiment of the present invention. Profood item 121 includes an outer shell that encases an interior that includes natural grains 122, such as: quinoa, sorghum, buckwheat, and the like. FIG. 2E is a cross-sectional schematic illustration of a pellet profood item 124 with enclosed foodstuffs 125, prepared in accordance with an embodiment of the present invention. Profood item 124 includes an outer shell that encases an interior that includes foodstuffs 125 such as chunks of dried vegetables, diced up fruits, and the like. FIG. 2F is a cross-sectional schematic illustration of a pellet profood item 127 with a hemispherical multi-component configuration, prepared in accordance with an embodiment of the present invention. Profood item 127 includes an outer shell coating an interior that is divided into a first hemisphere 128 having a first composition, and a second hemisphere 129 having a second composition including natural grains (such as natural grains 122 of profood item 121). FIG. 2G is a cross-sectional schematic illustration of a pellet profood item 131 with a core and shroud multi-component configuration, prepared in accordance with an embodiment of the present invention. Profood item 131 includes an outer shell coating an interior that is divided into an inner core 132 having a first composition, and an outer shroud 133 surrounding inner core 133 and having a second composition including natural grains (such as natural grains 122 of profood item 121). FIG. 2H is a cross-sectional schematic illustration of a pellet profood item 135 with a multi-component and multi-ingredient configuration, prepared in accordance with an embodiment of the present invention. Profood item 135 includes an outer shell coating an interior that includes two distinct sets of foodstuffs: a first foodstuff set 136, such as a natural dried fruit, and a second foodstuff set, such as edible seed or nut fragments. FIG. 2I is a cross-sectional schematic illustration of a conglomerate profood item 140 of conjoined pellets with different ingredients and configurations, prepared in accordance with an embodiment of the present invention. Profood item 140 is an agglomerate of multiple conjoined pellets 141, 142, 143, 144 each having a respective configuration and composition. In particular, pellet 141 includes a core and shroud multi-component configuration (similar to profood item 131 of FIG. 2G); pellet 142 includes a basic coated pellet configuration (similar to profood item 111 of FIG. 2C); pellet 143 includes a multi-component and multi-ingredient configuration (similar to profood item 135 of FIG. 2H); and pellet 144 includes a hemispherical multi-component configuration (similar to profood item 127 of FIG. 2F).

Referring back to FIG. 1, in procedure 130, the profood item is heated to induce the liquid of the second foodstuff contained within the profood shell to form a vapor. The heated profood increases the pressure of the formed vapor causing a rupturing of the shell when reaching breakage threshold conditions (i.e., above a certain temperature and pressure threshold), which induces a sudden release of the vapor at a high pressure, resulting in puffing and cooling of the starch to produce a puffed food product.

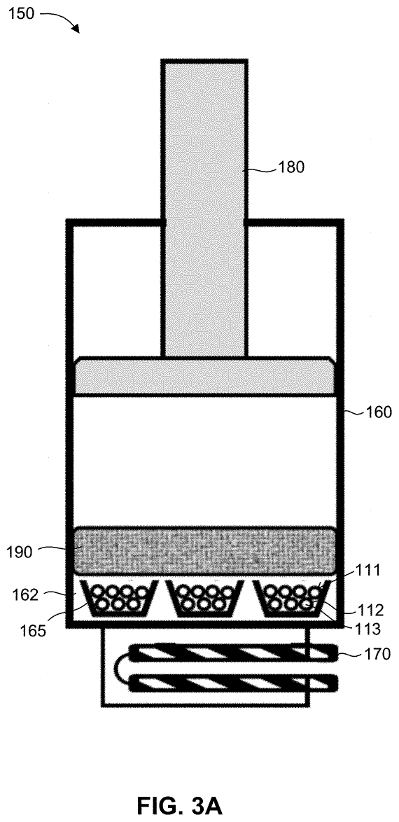

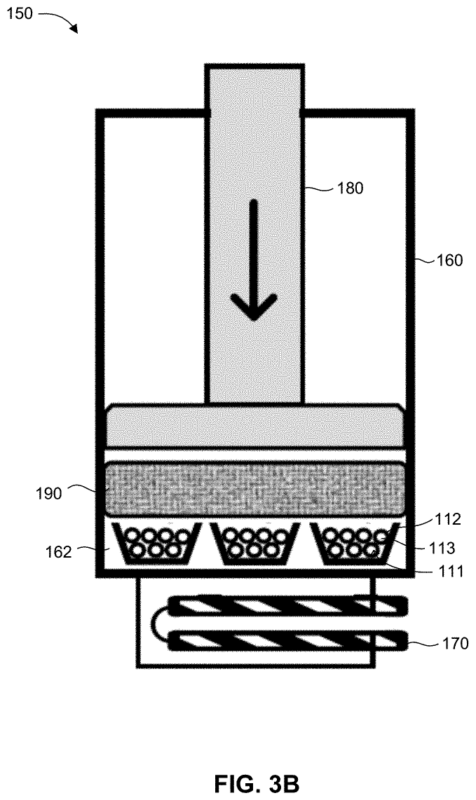

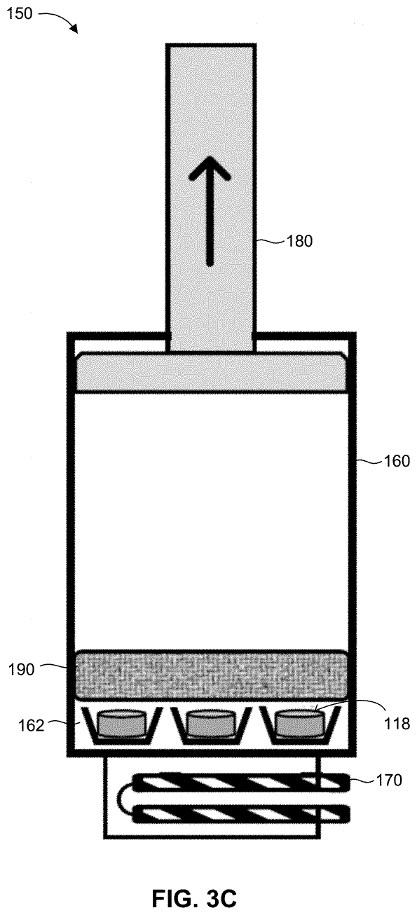

Reference is now made to FIGS. 3A, 3B and 3C, which are schematic illustrations of an apparatus, generally referenced 150, for preparation of a puffed food product, constructed and operative in accordance with an embodiment of the present invention. FIG. 3A depicts apparatus 150 in a first stage of operation, FIG. 3B depicts apparatus 150 in a second stage of operation, and FIG. 3C depicts apparatus 150 in a third stage of operation. Apparatus 150 includes a container 160 with at least one compartment 162. Apparatus 150 further includes a heating device 170, a pressure device 180, and an optional screening device 190.

Container 160 is configured to receive a plurality of profood items placed within compartment 162. Heating device 170 is configured to apply heat to compartment 162, and may be positioned adjacent to a wall or surface of compartment 162, such as underneath a bottom surface of compartment 160. For example, heating device 170 may be embodied by a portion of a stovetop or cooktop, such as a gas burner or an induction hob, or an open flame. Heating device 170 may include one or more electrical resistance heating elements located in the container walls, or integrated into a mold assembly (if such an assembly is used). Heating device 170 may apply heating through any suitable mechanism, including but not limited to: radiation; thermal conduction; magnetic induction; electrical heating; and the like.

Pressure device 180 is configured to increase or decrease the pressure within compartment 162, and may be positioned adjacent to a wall or surface of compartment 162, such as above an upper surface of compartment 160, or otherwise linked to compartment 160. Pressure device 180 may be embodied, for example, by an industrial vacuum pump with a valve leading into compartment 162, where pressure within compartment 162 can be selectively increased or decreased by operating the vacuum pump and opening the valve, such as to selectively allow gases or fluid to flow into or out of the compartment (resulting in a pressure differential). An accumulator may be coupled with the vacuum pump and valve to maintain and control the fluid flow.

Screening device 190 is positioned between compartment 162 and pressure device 180 and is configured to prevent foodstuff particles from escaping from compartment 162 and entering pressure device 180, which may lead to contamination and/or impair the functioning of pressure device 180. Screening device 190 may be embodied by at least one separator, including but not limited to one or more of: a grid, a screen, a filter, a dust collector, a gravitational or pressure differential separator, and combinations thereof. The separator may be removable and serviceable to facilitate the removal of proofood item particles or foodstuff substances from or in the separator.

Apparatus 150 may optionally include and/or be associated with additional components not shown in the Figures for enabling the implementation of the disclosed subject matter.

The operation of puffed food preparation apparatus 150 will now be described in general terms. A user places one or more profood items, such as profood items 111, within compartment 162 of container 160. The profood items may be placed within respective molds within compartment 162, such as mold 165, of predefined shape and size, and used in conjunction with a pressing mechanism, so as to induce a selected shape and/or size of the subsequently produced puffed food. For example, a metal mold may be situated in a hydraulic press, with electrical resistance heating elements located in the walls of the mold (similar to injection molding), where the heating elements are controlled by controllers such as a thermocouple (TC) sensor attached at a suitable point to detect the actual temperature. Alternatively, the profood items may be placed directly in compartment 162 without utilizing a dedicated mold (in which case compartment 162 essentially functions as a mold cavity). For example, profood items that are granular may need to be aggregated and may thus be placed into molds or into one or more designated cavities, whereas large profood items, such as whole fresh fruit, may be placed in a shell containing a significant amount of starch (e.g., at least 15% w/w of the shell) and prepared in compartment 162 without a mold. The filling of molds 165 may be important to ensure the integrity and intended shape of the final puffed food product. Furthermore, compartment 162 may be filled so as to leave minimal superfluous space within the compartment, in order to facilitate a rapid onset of the requisite pressure decrease during the preparation process for providing a proper and consistent shaped final puffed food product.

Apparatus 150 is initialized such that the temperature and pressure conditions in container 160 and compartment 162 are at default settings. For example, heating device 170 may be operating continuously and the heat regulated at a constant temperature by a regulator, while the pressure is at standard atmospheric pressure (i.e., room pressure) when pressure device is not applied. In a next operational stage (depicted in FIG. 3B), pressure device 180 is employed to (gradually) increase pressure in compartment 162, while substantially concurrently, heating device 170 is employed to (gradually) increase the temperature in compartment 162. For example, when using electrical resistance heating elements then the temperature is constant and regulated throughout, and when using induction or microwave heating then the temperature is varied on demand. The pressure increase or decrease is generally as rapid as possible, typically less than 0.2 seconds, and not longer than 1.0 second. Alternatively, if compartment 162 is effectively sealed then the pressure increase in compartment 162 may be achieved by raising the internal temperature using heating device 170 provided there is sufficient moisture content. Profood items 111 in compartment 162 are subject to increasing temperature and pressure levels, leading to the formation of vapor from the moisture content in profood interior 113. Eventually profood items 111 reach breakage threshold conditions at which the profood shell 112 breaks or ruptures due to the elevated vapor pressure. The heating of profood item 111 also causes a softening of the thermoplast biopolymer elements in the first foodstuff e.g., starch, in profood interior 113. It is noted that the stage depicted in FIG. 3B is optional, and pre-pressing is not required for all foodstuffs and conditions.

In a subsequent operational stage (depicted in FIG. 3C), pressure device 180 is employed to suddenly decrease the pressure in compartment 162, while heating device 170 maintains or increases the temperature in compartment 162. The pressure decrease may be achieved such as by rapidly hydraulically or pneumatically pulling a piston or vacuum pump of pressure device 180 or by opening a valve to a connected vacuum accumulator connected to a vacuum pump. As the pressure is rapidly decreased, the pressure difference between the extremely low pressure outside and the higher pressure within the profood item causes the shell 112 to rupture or “explode”, followed by an expansion of the first foodstuff substances in the profood interior 113 into a foamy structure. The first foodstuff starches then rapidly cools down and develops a puffed configuration to produce a puffed food item 118, as the starch and other materials in the profood interior 113 readily expanding and then rapidly cooling down helps to create an expanded foodstuff matrix. Each puffed food item 118, which may be in the form of an edible puffed cake that can be consumed as a snack, is typically created from multiple smaller micropellets.

The breakage may be achieved when the mold is abruptly opened and the pressure is rapidly released. The puffing expansion continues in the open air as the water vapor continues to escape the material matrix. The entire process from start to finish may be approximately 6-7 seconds, including the opening and closing of the molds (which take up the majority of the duration). A typical pressing time is between 0.1-2.0 seconds, depending on the material.

The amount or quantity of profood items initially placed within compartment 162 (or within molds therein) may be selected to ensure that the total volume of puffed foods produced, during a given production session or cycle, is sufficient to occupy most or all of the available space within compartment 162.

Compartment 162 may be characterized with a substantially low spatial volume, such that the pressure change (decrease) is substantially rapid, which may facilitate the process causing second foodstuff to suddenly rupture the profood shell 112 and enhance the puffing thereof, as compared with puffing performed by conventional systems with commercially available foodstuffs amendable to puffing. As the rapid expansion creates a sudden pressure drop in the compartment and/or mold, the pressure difference (AP) is higher, and induces the rupturing of the shell/coating. Furthermore, this characteristic may allow for puffing of novel types of profood items beyond conventional and commercially available foodstuffs, as the vacuum pressure can be created in the compartment and/or mold, so a higher pressure difference (AP) can be achieved and thus expansion and puffing can be induced even in materials or foodstuffs that do not tend to puff easily. The resulting puffed product may be crispier and airier than conventional puffed foods and may have a greater surface area, yet still lighter weight (e.g. less than 1 gram) in comparison to dense unpuffed crackers made from similar foodstuffs, and thus more pleasing and highly satiating.

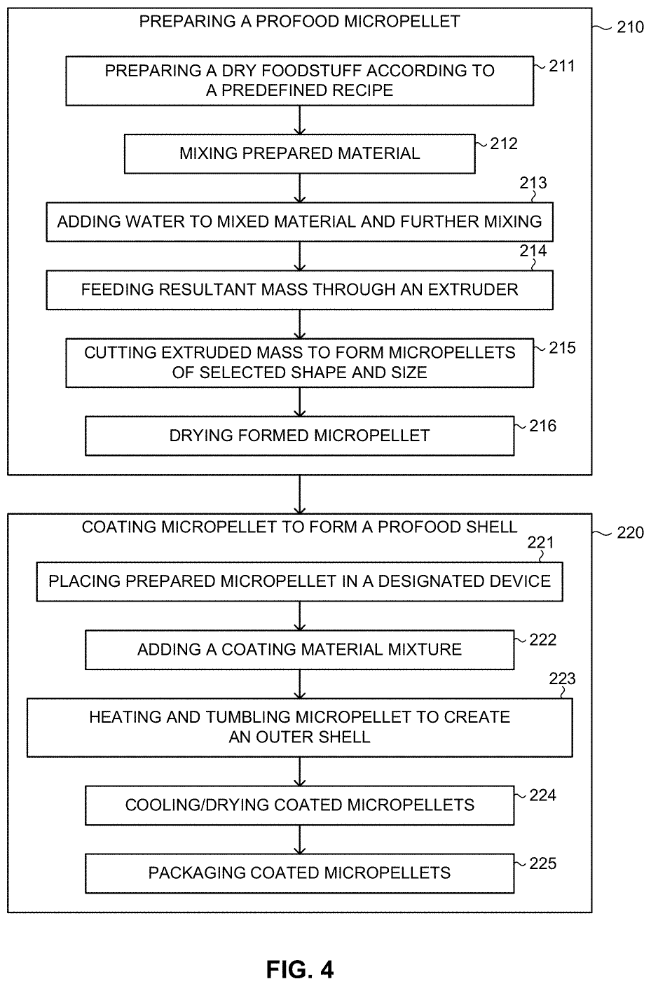

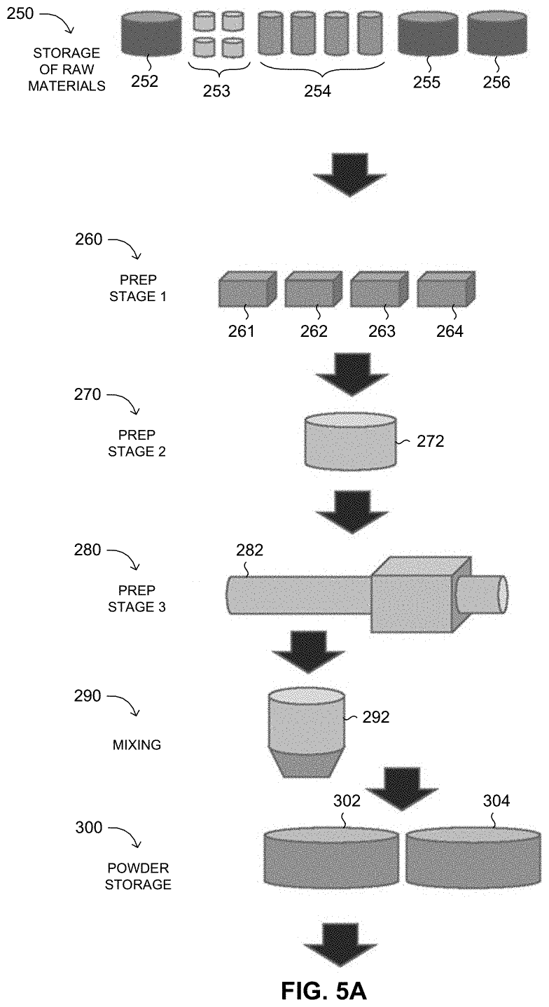

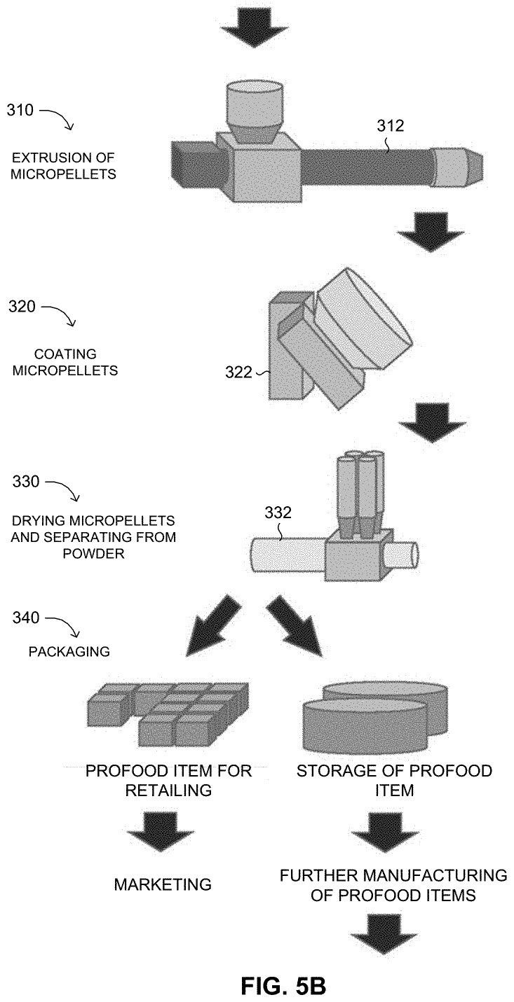

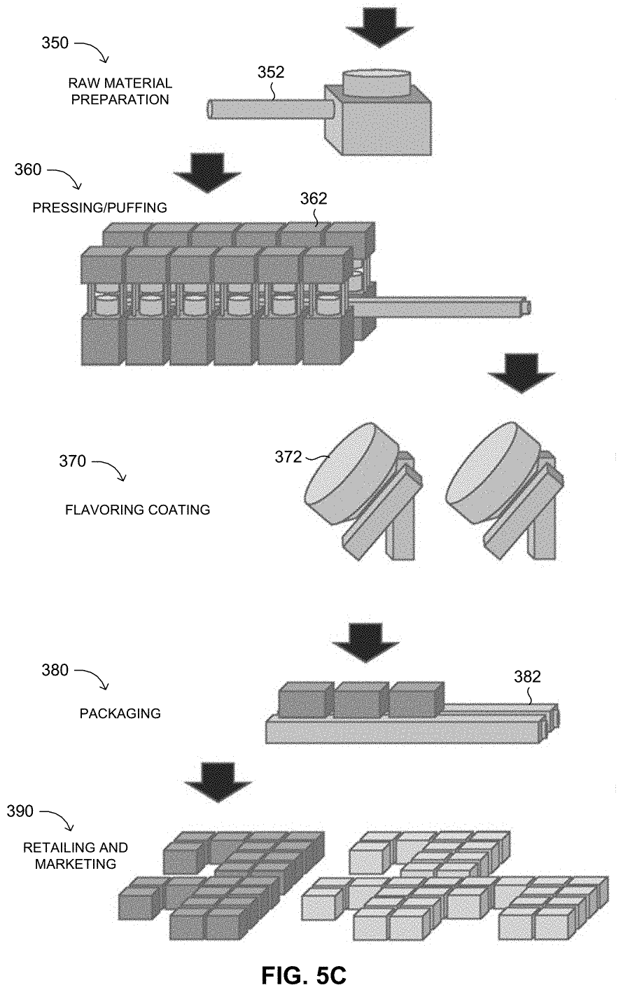

Reference is now made to FIG. 4, which is a flow diagram of a method for preparing a profood item, operative in accordance with an embodiment of the present invention. In procedure 210, a profood micropellet is prepared. Preparation of the profood micropellet is described herein using an extrusion process for exemplary purposes, but it is appreciated that other devices and techniques may alternatively be used to prepare the profood micropellet, such as by means of a granulating process. Accordingly, preparation of a profood micropellet using extrusion includes sub-procedures 211, 212, 213, 214, 215 and 216. In sub-procedure 211, a dry foodstuff is prepared according to a predefined recipe. Reference is made to FIGS. 5A, which is an illustration of initial stages of a production process for preparation of a profood item, operative in accordance with an embodiment of the present invention. In stage 250, raw materials of the food stuff are stored. These raw materials may include different types of grains (referenced 252, 255, 256), roots (253), lentils (254), vegetables and the like. The raw materials then undergo a first preparation stage (260), which may include milling (via mill 261), peeling (via peeler 262), grinding (via grinder 263), crushing (via crusher 264), and the like. Then the materials undergo a second preparation stage (270) involving wringing (via wringer 272) to remove liquids/moisture, followed by a third preparation stage (280) involving drying (via a drying apparatus 282). Each dry foodstuff is prepared according to a suitable recipe and process. For example, the dry foodstuff may include flours along with small pieces of dry fruits or vegetables, where fresh items may be dried and pulverized. Plant derived starch may be added if overall starch contents are too low.

In sub-procedure 212, the prepared material is mixed. Referring to FIG. 5A, the dry foodstuff (e.g., flours with pieces of dried fruits/vegetables) is mixed in stage 290 using a mixer 292. In an optional sub-procedure 213, water is added and the material is mixed further. A small amount of water may be added to aid the formation of a dough-like mass, with further kneading or mixing to unify the different portions of foodstuff composition (e.g., flours). The resultant material is then stored in a dry powdered form (depicted as elements 302, 304 in stage 300).

In sub-procedure 214, the resultant mass is fed through an extruder. Reference is made to FIG. 5B, which is an illustration of intermediate stages of the production process for preparation of a profood item. In stage 310, the dried powdered material (optionally with added water) is fed through an extruder 312. The mass is fed through one end of extruder 312, which continually mixes and presses the mass through the extruder barrel. The barrel may be heated or cooled if needed. The mass is pushed out at the other end of extruder 312 through a nozzle or a screen with multiple orifices. The mass exits the orifices in a designated form, such as a long thin strip (e.g., resembling a long strand of spaghetti). In sub-procedure 215, the extruded mass is cut or divided to form micropellets of selected sizes and shapes. The mass is cut up upon exiting the extruder orifices, such as to a length of approximately the diameter of the exiting thin strand, to create one or more small micropellets. The shape of each micropellet may vary, such as spherical or cylindrical or a similar intermediate shape. In sub-procedure 216, the formed micropellet is dried. Drying of the micropellet may be performed in a drying stage 330 after the shell coating process described below. Typically drying is performed after extrusion and cutting, but sometimes additional drying may be required after the coating process. If the micropellet shape is intended to be more spherical, then drying can be performed within a spheronizator nodulizer, or a tumble dryer.

In procedure 220 the profood micropellet is coated to form a shell. It is noted that the profood shell may alternatively be formed using processes and devices other than coating, including but not limited to: co-extrusion; surface treatment; injection or co-injection; a fluid bed; coating drums; and the like. Shell formation may also be performed by a heating and tumbling process, such as using a tumble dryer or dryer mixer. Accordingly, formation of a profood shell using a coating process includes sub-procedures 221, 222, 223, 224 and 225. In sub-procedure 221, a prepared micropellet is placed in a designated device, such as a tumble dryer, a fluid bed, or mixer. In an optional sub-procedure 222, a coating mixture is added to the micropellet. Coating mixtures and layers can be added in multiple consecutive steps, or in a single step. Referring to FIG. 5B, in stage 320 the micropellets are coated, such as via a mechanical or thermal surface treatment using a coating apparatus 322. Coating stage 320 may be carried out at other steps between extrusion stage 310 and raw materials preparation stage 350, such as before or after storage/packaging stage 340, and before or after micropellet drying stage 330. For some micropellets it is not necessary to add coating materials, and they may undergo heating and tumbling directly. In sub-procedure 223, the micropellet is heated and tumbled to create an outer shell. The created shell may be of the same material combination as the core but transformed and compacted, or may alternatively be a different coating material. When an added coating mixture is applied, the coating particles settle on the micropellet surface and solidify and crosslink to create a solid shell. In some instances, the settling of the coating particles can be improved by lightly watering the micropellets, or by application of a static electric charge. When a coating mixture is not added, the surface of the micropellet itself is treated by heat and the mechanical contact created during tumbling, creating an outer shell of essentially the same material combination as the core, but transformed and compacted, and crosslinked with the present starches, lignins, polysaccharides, and the like.

In an optional sub-procedure 224, the coated micropellets are cooled and/or dried. Cooling and/or drying of the coated micropellets may be performed in the context of the drying process depicted in stage 330. In a further sub-procedure 225, the coated micropellets are packaged. Referring to FIG. 5B, the coated micropellets are packaged to create a packaged profood item that can be sold and marketed (stage 340). Some of the coated micropellets may be marketed and retailed as profood items, while others may be stored for subsequent puffing into a puffed food product (as shown in FIG. 5B).

It is noted that some of the sub-procedures of the method of FIG. 4 may be omitted and/or may be carried out at alternate stages than described hereinabove (e.g., before or after the respective steps).

Reference is made to FIG. 5C, which is an illustration of final stages of the production process for preparation of a profood item. After the early preparation stages for producing the profood pellets (depicted in FIG. 5A) and after the profood pellets are actually prepared and are ready for puffing (depicted FIG. 5B), the profood pellets are then converting into a final puffed product (e.g., a puffed cake or other snack) which is ready for marketing. The profood items undergoes raw material preparation in stage 350, a pressing or puffing stage 360, a flavor coating stage 370, followed by packaging 380, and then retail and marketing 390.

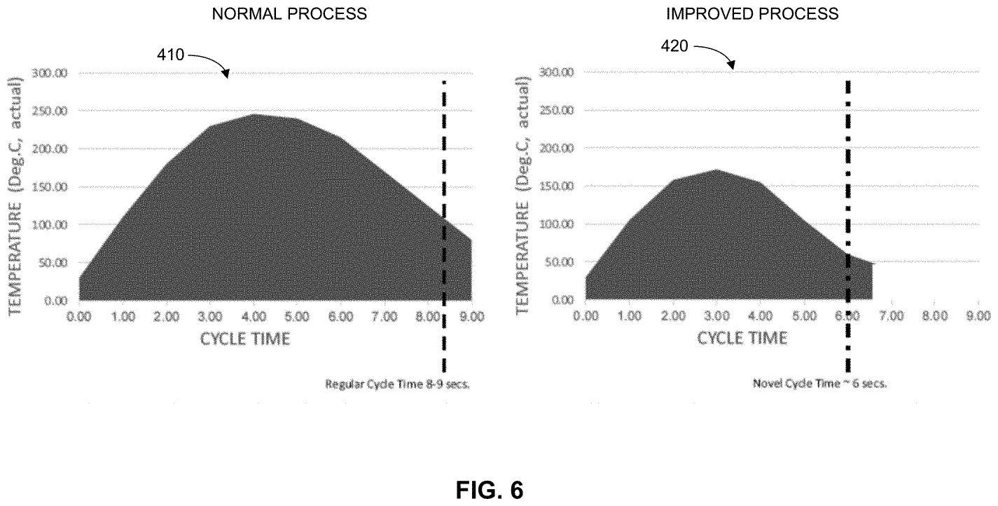

Reference is made to FIG. 6, which is a schematic illustration comparing the nutritional degradation profile, generally referenced 410, of a commercial puffing process and puffed food product, with the nutritional degradation profile, generally referenced 420, of the disclosed puffing process and puffed food product in accordance with embodiments of the present invention. Graphs 410, 420 schematically depict the degradation of the nutritional content as a function of temperature and cycle time combined. The y-axis of graphs 410, 420 represents the process temperature. The higher the process temperature, the greater the degradation of nutritional qualities. The x-axis of graphs 410, 420 represents the cycle time or process time. The longer the cycle time, the more exposure to high temperatures, and the greater the degradation of the nutritional qualities. The total nutritional degradation is represented by the cross-hatched area, between the curve and the baseline. Graph 420 represent an exemplary puffing process of the present invention using a coated micropellet (i.e., having a shell) and vacuum enhanced puffing.

It is evident from graphs 410, 420 that the exemplary puffing process of the present invention reduces process temperatures by about 50-60 degrees Celsius and thus significantly minimizes nutritional degradation Furthermore, the exemplary puffing process of the present invention reduces the cycle time by at least 30-40%, thus significantly minimizing nutritional degradation. The accumulated effect of reduction of process temperatures and cycle time is tremendous, as can be observed by the difference in the cross hatched areas of graph 420 relative to graph 410. Accordingly, the puffing process of the present invention clearly shows a nutritional degradation reduced to roughly 40-60% compared to the degradation extent present in conventional or commercial puffing processes, thereby providing a more nutritious puffed food product. Moreover, a shorter cycle time and lower process temperatures provide economic benefits in the form of lower energy consumption and higher efficiency (in terms of number of units produced during a given time period).

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1-14. (canceled)

15. A profood item for preparing a puffed food product, the profood item comprising:
a shell, comprising a shell foodstuff, the shell characterized by a hardness and rigidity able to withstand breakage when subject to a temperature and pressure below breakage threshold conditions; and
an interior, contained within the shell, the interior comprising an interior foodstuff comprising: at least one starch; and a liquid adapted to form a vapor when subjected to heating, wherein an increased pressure of the vapor when the profood item is subjected to heating causes a rupturing of the shell when the breakage threshold conditions is reached, inducing a sudden release of the vapor at a high pressure, resulting in puffing of the starch to produce the puffed food product,
wherein the interior foodstuff comprises:
a first interior component selected from the group consisting of: a vegetable; and a fruit; and
less than 10% w/w interior of a second interior component selected from the group consisting of: dried sorghum, rice, corn, wheat, potato, cereals, and mixtures thereof.

16. A profood item for preparing a puffed food product, the profood item comprising:
a shell, comprising a shell foodstuff, the shell characterized by a hardness and rigidity able to withstand breakage when subject to a temperature and pressure below breakage threshold conditions; and
an interior, contained within the shell, the interior comprising an interior foodstuff comprising: at least one starch; and a liquid adapted to form a vapor when subjected to heating, wherein an increased pressure of the vapor when the profood item is subjected to heating causes a rupturing of the shell when the breakage threshold conditions is reached, inducing a sudden release of the vapor at a high pressure, resulting in puffing of the starch to produce the puffed food product,
wherein the interior foodstuff comprises a first interior component selected from the group consisting of: a vegetable; a fruit; and a legume; and
wherein the interior foodstuff does not comprise any of a component selected from the group consisting of: dried sorghum, rice, corn, wheat, potato, cereals, and mixtures thereof, thereby providing the starch of the interior foodstuff only from the first interior component.

17. The profood item of claim 15, wherein the first interior component comprises at least 10% (w/w interior) of at least one of the group consisting of: edible root plants; edible bulbs; sweet potato; radish; beet; lentil; chickpea; sweet pea; edible mushroom; bell pepper; hot pepper; chilli pepper; tomato; zucchini; pumpkin; onion; garlic; celery; spinach; apple; citrus fruit; blueberry; blackberry; raspberry; egg; cheese; milk or derivatives thereof; meat and meat substitutes; fish and fish substitutes; algae and/or seaweed; soy; bean; avocado; avocado pit; moringa; quinoa; amaranth; whey; soy; soy derived proteins; preparations thereof; and mixtures thereof.

18. The profood item of claim 15, wherein the shell foodstuff comprises at least 10% weight by weight (w/w) of at least one of the group consisting of: zein; edible cellulose; edible fatty acids; lipids; furfuryl alcohol; polysaccharide; bran; natural edible fibre; plant derived edible thermoplasts; edible biopolymers; lignin; lignin-polysaccharide combinations; starch; lignin-starch combinations; amylose; amylopectin; amylose-amylopectin combinations; amaranth; pectin; alginic acid; alginate; beta-glucans; chitosan; cellulose nanocrystal (CNC); whey; prolamin; avenin; gliadin; hordein; secalin; kafirin; bean; pea; chickpea; lentil; preparations thereof; and mixtures thereof.

19. The profood item of claim 15, wherein the interior foodstuff is not any of the group consisting of: drageés, chocolate covered nuts and fruit, frozen foods, processed cheese, nuggets, and crunchy nuts.

20. The profood item of claim 15, wherein the interior foodstuff comprises 10-35% w/w of a natural plant derived starch.

21. A method for producing a profood item used for preparing a puffed food product, the method comprising the procedures of:
preparing a micropellet, the micropellet comprising an interior foodstuff comprising: at least one starch; and a liquid adapted to form a vapor when subjected to heating;
coating the micropellet to form a shell comprising a shell foodstuff, the shell characterized by a hardness and rigidity able to withstand breakage when subject to a temperature and pressure below breakage threshold conditions,
wherein an increased pressure of the vapor when subjected to heating causes a rupturing of the shell when breakage threshold conditions of the shell is reached, inducing a sudden release of the vapor at a high pressure, resulting in puffing of the starch to produce the puffed food product,
wherein the interior foodstuff comprises:
a first interior component selected from the group consisting of: a vegetable; and a fruit; and
less than 10% w/w interior of a second interior component selected from the group consisting of: dried sorghum, rice, corn, wheat, potato, cereals, and mixtures thereof.

22. A method for producing a profood item used for preparing a puffed food product, the method comprising the procedures of:
preparing a micropellet, the micropellet comprising an interior foodstuff comprising: at least one starch; and a liquid adapted to form a vapor when subjected to heating;
coating the micropellet to form a shell comprising a shell foodstuff, the shell characterized by a hardness and rigidity able to withstand breakage when subject to a temperature and pressure below breakage threshold conditions,
wherein an increased pressure of the vapor when subjected to heating causes a rupturing of the shell when breakage threshold conditions of the shell is reached, inducing a sudden release of the vapor at a high pressure, resulting in puffing of the starch to produce the puffed food product,
wherein the interior foodstuff comprises a first interior component selected from the group consisting of: a vegetable; a fruit; and a legume; and
wherein the interior foodstuff does not comprise any of a component selected from the group consisting of: dried sorghum, rice, corn, wheat, potato, cereals, and mixtures thereof, thereby providing the starch of the interior foodstuff only from the first interior component.

23. The method of claim 21, wherein preparing the micropellet comprises at least one sub-procedure selected from the group consisting of:
preparing a dry foodstuff according to a predefined recipe;
mixing the prepared dry foodstuff material;
adding water to the mixed material and further mixing;
feeding the resultant mass through an extruder;
cutting up extruded mass to form at least one micropellet of a selected size and shape; and
drying the formed micropellet.

24. The method of claim 21, wherein coating the micropellet to form a shell comprises at least one sub-procedure selected from the group consisting of:
placing at least one prepared micropellet in a designated device for coating;
adding a coating material mixture to the micropellet;
heating and tumbling the micropellet to create an outer shell;
cooling and/or drying the coated micropellet; and
packaging the coated micropellet.

25. A puffed food product prepared from a profood item of claim 15.

26. A method for preparing a puffed food product, the method comprising the procedures of:
providing a profood item as in claim 15;
heating the profood item to induce the liquid contained within the second foodstuff to form a vapor; and
heating the profood item to induce an increased pressure of the vapor within the interior, until a rupturing of the shell at the breakage threshold conditions induces a sudden release of a high pressure of the vapor resulting in puffing of the starch to produce the puffed food product.

27. The profood item of claim 16, wherein the first interior component comprises at least 10% (w/w interior) of at least one of the group consisting of: edible root plants; edible bulbs; sweet potato; radish; beet; lentil; chickpea; sweet pea; edible mushroom; bell pepper; hot pepper; chilli pepper; tomato; zucchini; pumpkin; onion; garlic; celery; spinach; apple; citrus fruit; blueberry; blackberry; raspberry; egg; cheese; milk or derivatives thereof; meat and meat substitutes; fish and fish substitutes; algae and/or seaweed; soy; bean; avocado; avocado pit; moringa; quinoa; amaranth; whey; soy; soy derived proteins; preparations thereof; and mixtures thereof.

28. The profood item of claim 16, wherein the shell foodstuff comprises at least 10% weight by weight (w/w) of at least one of the group consisting of: zein; edible cellulose; edible fatty acids; lipids; furfuryl alcohol; polysaccharide; bran; natural edible fibre; plant derived edible thermoplasts; edible biopolymers; lignin; lignin-polysaccharide combinations; starch; lignin-starch combinations; amylose; amylopectin; amylose-amylopectin combinations; amaranth; pectin; alginic acid; alginate; beta-glucans; chitosan; cellulose nanocrystal (CNC); whey; prolamin; avenin; gliadin; hordein; secalin; kafirin; bean; pea; chickpea; lentil; preparations thereof; and mixtures thereof.

29. The profood item of claim 16, wherein the interior foodstuff is not any of the group consisting of: drageés, chocolate covered nuts and fruit, frozen foods, processed cheese, nuggets, and crunchy nuts.

30. The profood item of claim 16, wherein the interior foodstuff comprises 10-35% w/w of a natural plant derived starch.

31. The method of claim 22, wherein preparing the micropellet comprises at least one sub-procedure selected from the group consisting of:
preparing a dry foodstuff according to a predefined recipe;
mixing the prepared dry foodstuff material;
adding water to the mixed material and further mixing;
feeding the resultant mass through an extruder;
cutting up extruded mass to form at least one micropellet of a selected size and shape; and
drying the formed micropellet.

32. The method of claim 22, wherein coating the micropellet to form a shell comprises at least one sub-procedure selected from the group consisting of:
placing at least one prepared micropellet in a designated device for coating;
adding a coating material mixture to the micropellet;
heating and tumbling the micropellet to create an outer shell;
cooling and/or drying the coated micropellet; and
packaging the coated micropellet.

33. A puffed food product prepared from a profood item of claim 16.

34. A method for preparing a puffed food product, the method comprising the procedures of:
providing a profood item as in claim 16;
heating the profood item to induce the liquid contained within the second foodstuff to form a vapor; and
heating the profood item to induce an increased pressure of the vapor within the interior, until a rupturing of the shell at the breakage threshold conditions induces a sudden release of a high pressure of the vapor resulting in puffing of the starch to produce the puffed food product.
